(19) United States
(12) Patent Application Publication
(10) Pub. No.: US 2024/0276625 A1
(43) Pub. Date: Aug. 15, 2024

(54) VUV LASER-SUSTAINED PLASMA LIGHT SOURCE WITH LONG-PASS FILTERING

(71) Applicant: KLA Corporation, Milpitas, CA (US)

(72) Inventors: Ilya Bezel, Mountain View, CA (US); Patrick Casey, Morgan Hill, CA (US)

(21) Appl. No.: 18/438,165

(22) Filed: Feb. 9, 2024

Related U.S. Application Data
(60) Provisional application No. 63/446,911, filed on Feb. 20, 2023.
(60) Provisional application No. 63/445,307, filed on Feb. 14, 2023.

(51) Int. Cl. H05G 2/00

(52) U.S. Cl. CPC H05G 2/008

(57) ABSTRACT

A laser-sustained broadband light source is disclosed. The light source may include a gas containment structure containing a mixture of a first noble gas and a second noble gas. The light source may include a laser pump source to generate an optical pump to sustain a plasma within the gas containment structure. The first noble gas absorbs broadband light within a first wavelength band and a second wavelength band. The light source may include a filter positioned within the gas containment structure and configured to absorb the broadband light emitted by the plasma having a wavelength below a selected wavelength threshold. The absorption of broadband light by the first noble gas and the filter provide long-pass filtering of broadband light below the selected wavelength to protect one or more downstream optical elements from damage.

### CROSS-REFERENCE TO RELATED APPLICATION

The present application claims priority to U.S. Provisional Application Ser. No. 63/445,307, filed Feb. 14, 2023, and United States Provisional Application Ser. No. 63/446,911, filed on Feb. 20, 2023, which are incorporated herein by reference in their entirety.

### TECHNICAL FIELD

The present invention generally relates to plasma-based radiation sources, and, more particularly, to a high-power vacuum ultraviolet (VUV) laser-sustained plasma (LSP) light source with long-pass filtering.

### BACKGROUND

Laser-sustained plasma (LSP) light sources are widely used in broadband inspection tools for use in semiconductor inspection and imaging. Generally, near-Infrared (NIR) Continuous Wave (CW) pump laser light is focused to a gas-containing vessel, where a plasma is ignited and sustained by absorption of the pump laser radiation. This vessel may be a lamp (e.g., glass bulb with or without electrodes used for plasma ignition), or a cell (e.g., optomechanical assembly with transparent walls to allow laser and plasma radiation in and out of the cell), or a chamber (e.g., metal vessel with transparent windows for laser light input and plasma light output), or similar assembly. The various plasma vessels have high internal pressure, which in operation reaches many tens or over a hundred atmospheres. This high-pressure gas contained in the vessel is crucial for LSP operation. The plasma light is collected through transparent walls or windows of the vessel and is used as an illumination source for inspection tools.

There have been various versions of such sources developed. Most of these sources are designed to operate in the Visible (VIS) or Ultra-Violet (UV) spectral regions. When these sources are used to generate light in the vacuum ultraviolet (VUV) spectral region, and especially in the range of approximately 125-150 nm, the choice of practical constructions is relatively small, and it is limited to relatively low pump powers. A typical source for generating VUV light includes a metal chamber with multiple windows which couple the laser light in and out of the chamber. While different materials can be used for the laser windows, few choices exist for VUV generation. The most widely used in MgF2, with the transmission cut-off wavelength of approximately 115 nm or CaF₂ with the transmission cut-off wavelength of approximately 125 nm.

One of the most significant limitations for operation of such a VUV source is optical damage to MgF₂ windows and downstream optics. All transmissive and reflective optics are damaged rapidly when being exposed to short-wavelength radiation. Bulk MgF₂ material and reflector coatings containing MgF₂ are severely damaged by radiation at or near the 115 nm absorption band edge. Currently, few options exist to avoid optical damage to these materials present in both the light source and downstream optics. Transmissive optical components directly irradiated by the plasma and the down-stream optics experience significant damage to bulk material caused by the wavelengths penetrating into and absorbed by the bulk. Reflective components are also damaged rapidly by the wavelengths shorter than about 125 nm. Wavelengths longer than approximately 117 nm propagate through longer distances in MgF₂, causing damage to downstream optics. Damage to optical components is greatly reduced if the irradiation wavelengths are longer than about 125 nm.

Another significant problem involves thermal management of windows within a high-power LSP which is due to the overheating of MgF₂ windows caused by the absorption of light by MgF₂. Overheating jeopardizes the structural strength of the MgF₂ window. Moving the window further away from the plasma makes cooling easier, but it increases the structural load on the window.

Therefore, it would be desirable to provide a VUV broadband light source that overcomes the limitations outlined above.

### SUMMARY

A laser-sustained broadband light source is disclosed. In some aspects, the laser-sustained broadband light source includes: a gas containment structure containing a mixture of a first noble gas and a second noble gas, a laser pump source configured to generate an optical pump to sustain a plasma within the gas containment structure, wherein the plasma generates broadband light, wherein the first noble gas absorbs a portion of the broadband light within a first wavelength band and a second wavelength band; and a filter positioned within the gas containment structure and configured to absorb a portion of the broadband light emitted by the plasma having a wavelength below a selected wavelength threshold, wherein absorption of broadband light by the first noble gas and the filter provide long-pass filtering of broadband light below the selected wavelength to protect one or more downstream optical elements from damage.

A characterization system is disclosed. In some aspects, the characterization system includes: a broadband light source including: a gas containment structure containing a mixture of a first noble gas and a second noble gas, a laser pump source configured to generate an optical pump to sustain a plasma within the gas containment structure, wherein the plasma generates broadband light; wherein the first noble gas absorbs a portion of the broadband light within a first wavelength band and a second wavelength band; and a filter positioned within the gas containment structure and configured to absorb a portion of the broadband light emitted by the plasma having a wavelength below a selected wavelength threshold, wherein absorption of broadband light by the first noble gas and the filter provide long-pass filtering of broadband light below the selected wavelength to protect one or more downstream optical elements from damage; and a light collector element configured to collect at least a portion of broadband light emitted from the plasma; a set of illumination optics configured to direct broadband light from the broadband light source to one or more samples; a set of collection optics configured to collect light emanating from the one or more samples; and a detector assembly.

A method of generating VUV broadband light is disclosed. In some aspects, the method includes: containing a mixture of a first noble gas and a second noble gas within a gas containment structure; generating an optical pump and directing the optical pump within the gas containment structure to sustain a plasma within the gas containment structure to generate broadband light; providing long-pass filtering of the broadband light, wherein the providing long-pass filtering of the broadband light includes: absorbing a portion of broadband light within a first wavelength band and a second wavelength band via the first noble gas; and absorbing a portion of the broadband light having a wavelength below a selected wavelength threshold via a filter.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures.

FIG. 1 illustrates a simplified schematic view of a laser-sustained plasma (LSP) broadband light source with long-pass filtering, in accordance with one or more embodiments of the present disclosure.

FIG. 2 illustrates a data graph depicting the transmission characteristics of the materials of the LSP broadband light source in the case of a CaF₂ filter and a gas mixture of Ar/Kr, in accordance with one or more embodiments of the present disclosure.

FIG. 3 illustrates a simplified schematic view of the LSP broadband light source with a filter tube, in accordance with one or more embodiments of the present disclosure.

FIG. 4 illustrates a simplified schematic view of the LSP broadband light source with an elliptical reflector assembly, in accordance with one or more embodiments of the present disclosure.

FIG. 5 illustrates a simplified schematic view of with LSP broadband light source with a pressurized reflector assembly, in accordance with one or more embodiments of the present disclosure.

FIG. 6 illustrates a simplified schematic view of a characterization system incorporating the LSP broadband light source, in accordance with one or more alternative and/or additional embodiments of the present disclosure.

FIG. 7 illustrates a process flow diagram depicting a method of generating VUV light with the LSP broadband light source with long-pass filtering, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

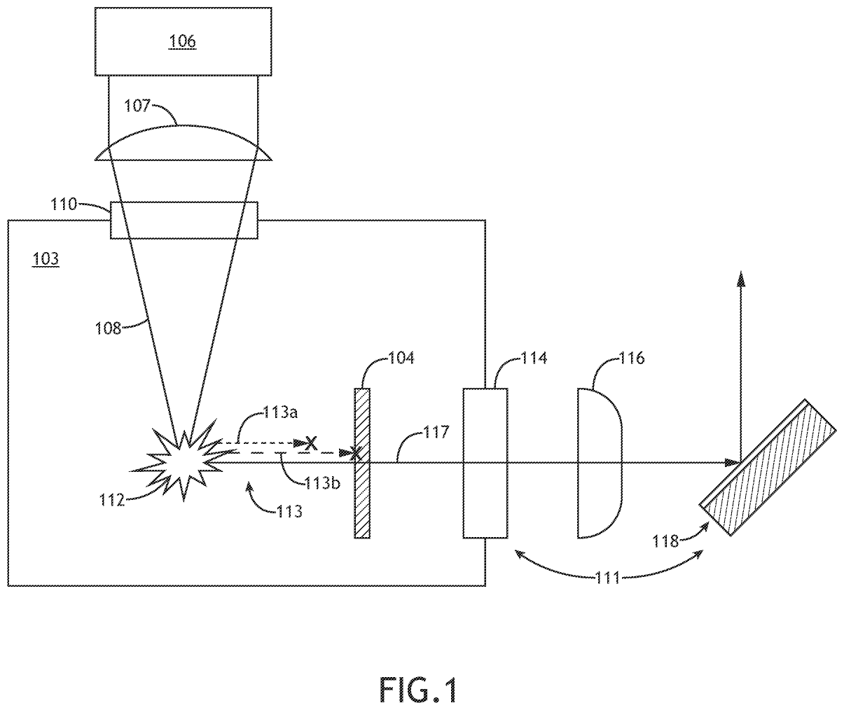

Referring generally to FIGS. 1-6, a VUV laser-sustained plasma broadband light source with long-pass filtering is described, in accordance with one or more embodiments of the present disclosure.

Embodiments of the present disclosure are directed to an LSP broadband light source having long-pass filtering. In embodiments, long-pass filtering is accomplished through the select combination of gas mixtures and materials used in one or more filters (e.g., filter sheet, filter tube, etc.). The filter material used in a particular filter is selected to provide substantial absorption of light having wavelengths below a selected threshold. For instance, in the case of a CaF₂ filter, the CaF₂ filter may provide strong absorption of light below approximately 125 nm. In combination with the filter material, a gas mixture, which surrounds the filter, is selected such that the one or more components of the gas mixture display one or more strong absorption lines near i) an absorption edge of the one or more downstream optics (e.g., window, mirror, lens) to protect the one or more downstream optics from degradation; and/or ii) an absorption edge of the filter itself to protect the filter from degradation. For instance, in a setting where it is desired to protect MgF₂ optics (e.g., MgF₂ window, MgF₂ coated mirror, MgF₂ lens), a CaF₂ filter may be used that provides strong absorption of light below 125 nm, which generally protects the MgF₂ optics. In addition, the inclusion of Kr within the plasma-generating gas mixture of the light source further provides a strong absorption band around the CaF₂ absorption edge, thereby protecting the CaF₂ filter itself. The absorption band of the Kr gas may be widened by increasing the partial pressure of the Kr gas in the gas mixture. U.S. application Ser. No. 18/438,025, filed on Feb. 9, 2024, is incorporated herein by reference in the entirety.

FIG. 1 illustrates a simplified schematic view of a LSP broadband light source 100 with long-pass filtering, in accordance with one or more embodiments. In embodiments, the light source 100 includes a gas containment structure 102 containing a mixture of a first noble gas (e.g., Kr) and a second noble gas (e.g., Ar). In embodiments, the light source 100 includes a filter 104 (e.g., CaF₂ filter) positioned within the gas containment structure 102. In embodiments, the light source 100 includes a laser pump source 106 configured to generate an optical pump 108. The laser pump source 106 and one or more focusing optics 107 may direct and focus the optical pump 108 through an input optical window 110 to sustain a plasma 112 within the gas containment structure 102 to generate broadband light 113. The laser pump source 106 may include any laser known in the art of plasma-based broadband light generation. In embodiments, the laser pump source 106 may include one or more continuous wave (CW) pump lasers and/or one or more pulsed lasers. For example, the laser pump source 106 may include, but is not limited to, a fiber laser, a thin-disk laser, a frequency-doubled laser, or a diode laser. The laser pump source 106 may be configured to emit light in the visible, IR (e.g., NIR), or ultraviolet regions.

In embodiments, the first noble gas absorbs a portion of the broadband light 113a within a first wavelength band and a second wavelength band. The filter 104 may absorb a portion of the broadband light 113b having a wavelength below a selected wavelength threshold. The absorption of broadband light 113 (combination of 113a and 113b) by the first noble gas and the filter 104 provide long-pass filtering of broadband light 113 below the selected wavelength to protect one or more downstream optical elements 111 (e.g., lenses, mirrors, windows) from damage. The one or more downstream optical elements 111 may include, but are not limited to, one or more windows 114, one or more lenses 116, or one or more mirrors 118 (e.g., MF₂ coated aluminum mirrors). In embodiments, the outputted filtered broadband light 117 is transmitted out of the gas containment structure 102 through an output optical window 114 (e.g., MgF₂ window).

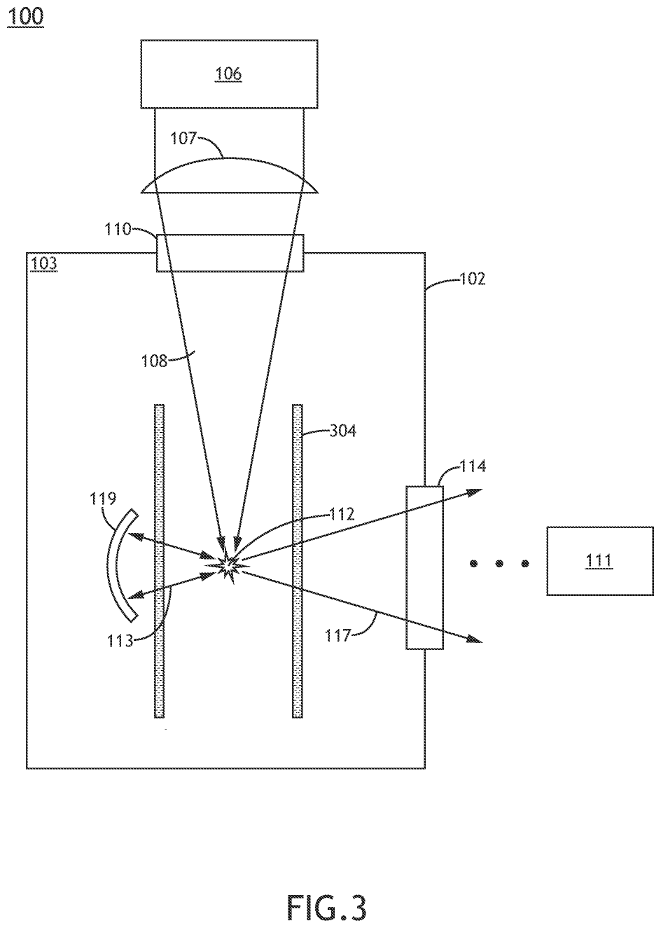

In embodiments, although not shown in FIG. 1, the light source 100 includes one or more collection optical elements for collecting the filtered broadband light 117 and transmitting the filtered broadband light 117 through an output optical window (e.g., MgF₂ window) to one or more downstream optical elements outside of the gas containment structure 102. For example, the light source 100 may include a collection mirror such as, but not limited to, a retroreflector. Multiple collection arrangements are described in further detail with respect to FIGS. 3, 4, and 5.

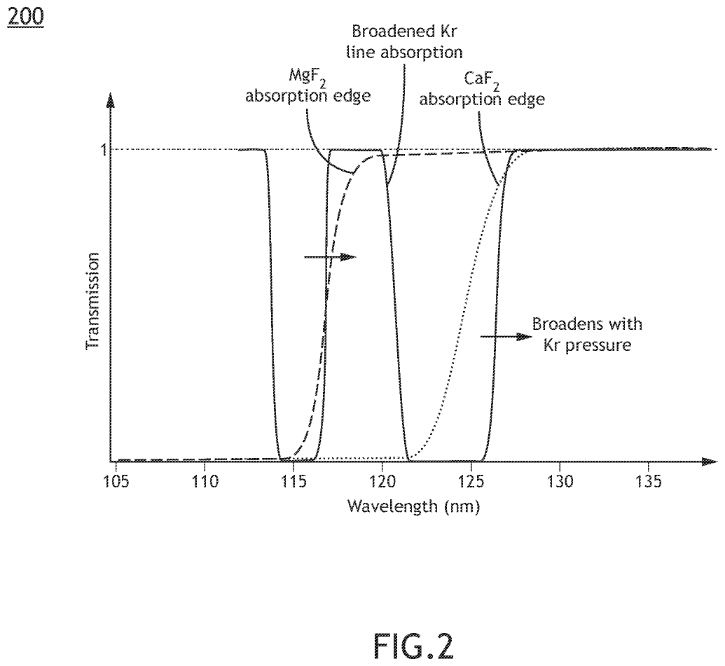

It is noted that the first noble gas and the material of the filter may be selected to achieve the desired long-pass filtering characteristics and may include a variety of first noble gas and filter tube material combinations. It is noted that the scope of the present disclosure should not be interpreted to be limited to any a particular noble gas or filter material. By way of example, in a first combination, the first noble gas may include krypton, the second noble gas may include argon, and the material of the filter may include CaF₂. Such a combination is particularly useful for protecting MgF₂-based optical elements (e.g., output windows, collection lenses, mirrors, etc.) from the broadband output. FIG. 2 illustrates a data graph depicting the transmission characteristics of the materials of the light source 100 in the case of a CaF₂ filter and a gas mixture of Ar/Kr. Krypton has an absorption line centered at approximately 124 nm and thus blocks radiation at the CaF₂ 123 nm absorption edge, thereby protecting the CaF₂ filter itself from damage. A small amount of Kr can be added to Ar with the thin CaF₂ filter. The Kr absorbs some amount of light at approximately 116 nm and 124 nm spectral bands (e.g., see FIG. 2). Absorption in these spectral bands is caused by very strong absorptive transitions originating from the ground state, which tend to broaden to the red from the main transition wavelength of 123.58 nm and 116.49 nm. The inclusion of a thin CaF₂ filter removes remaining light below 125 nm. The CaF₂ absorption edge of the filter 104 is protected by Kr the absorption (e.g., see FIG. 2). It is noted the CaF₂ filter does not have to carry structural load, and it can be made thin enough to transmit most of >125 nm light. Kr provides a sharper absorption edge than just simple CaF₂ filter and also protects CaF₂ from much of radiation near CaF₂ absorption edge, which reduces damage to the bulk of the material. The transmission edge may shit of larger wavelength as the partial pressure of the first noble gas is increased. For example, the resulting long-pass filter has a transmission edge at about 125 nm tunable to the red by increasing Kr partial pressure. The filtered broadband light 117 emitted from the light source 100 is not as damaging to MgF₂, nor is it absorbed by MgF₂ windows or other optics given the MgF₂ absorption edge is at approximately 116 nm which is below the 125 nm cutoff of the filtered broadband light 117. In addition, structural components of the gas containment structure 102 may be placed at relatively large distances from the plasma 112, thereby reducing the radiative heat load and making their cooling easier and their operating temperature lower. Low temperatures of the windows and chamber walls reduce the noise from refraction.

By way of another example, in a second combination, the first noble gas may include xenon (e.g., xenon mixed with argon) and the filter 104 may include sapphire. In this case, sapphire bulk damage is reduced by the Xe 146.96 nm absorption line which coincides with the sapphire absorption edge, thereby protecting the sapphire filter tube from damage. It is noted that the gas mixture within the gas containment structure is not limited to Kr/Ar or Xe/Ar. For example, the gas may include a few percent of Kr in Ar, pure Kr, a Ar/Kr/Xe mixture, pure Xe, and so on. The addition of Xe blocks emission below about 132-136 nm and in the 144 to about 150-160 nm band depending on Xe partial pressure. Utilizing different mixture gases and gas combinations allows for the protection of different filter tube and output window materials. For example, Ar mixed with a few percent of Kr and Xe gas may be used in combination with a crystal quartz, fused silica, CaF₂ or sapphire filter tube and the output and laser windows may be made of fused silica, sapphire, MgF₂, or CaF₂.

It is noted that the configuration depicted in FIG. 1 is not a limitation on the scope of the present disclosure and the light source 100 and filter 104 may be arranged in a variety of suitable configurations.

In embodiments, the partial pressure of the first noble gas may be independent controlled in the regions in front of and behind the filter 104 such that there is little or no pressure differential across the filter 104. For example, the cases of a Kr/Ar gas mixture and a CaF₂ filter, the Kr partial pressure may be independently controlled in the region in front and behind the CaF₂ filter with little or no pressure differential across the CaF₂ filter. For instance, in front of the CaF₂ filter, the gas mixture may include a 1 bar Kr partial pressure with a 99 bar Ar partial pressure and behind the filter the gas mixture may include a 100-bar partial pressure of Kr. This is useful for increasing LSP brightness as when adding too much Kr (or Xe) to Ar results in dimmer plasma with lower spectral radiance.

FIG. 3 illustrates a simplified schematic view of the light source 100 equipped with a filter 104 formed in a tubular structure to form a filter tube 304, in accordance with one or more embodiments of the present disclosure. It is noted that the various implementations and components described previously herein with respect to FIGS. 1-2 should be interpreted to extend to FIG. 3 unless otherwise noted. In this embodiment, the laser pump source 106 and one or more focusing optics 107 may direct and focus the optical pump 108 through an input optical window 110 to sustain a plasma 112 within the filter tube 304 to generate broadband light 113. Then, the gas mixture 103 and the filter tube 304 may filter the broadband light to generate the filtered broadband light 117 output. In this embodiment, the light source 100 includes one or more collection optical elements for collecting the filtered broadband light 117 and transmitting the filtered broadband light 117 through an output optical window to one or more downstream optical elements outside of the gas containment structure 102. For example, the light source 100 may include a collection mirror such as, but not limited to, a retroreflector 119.

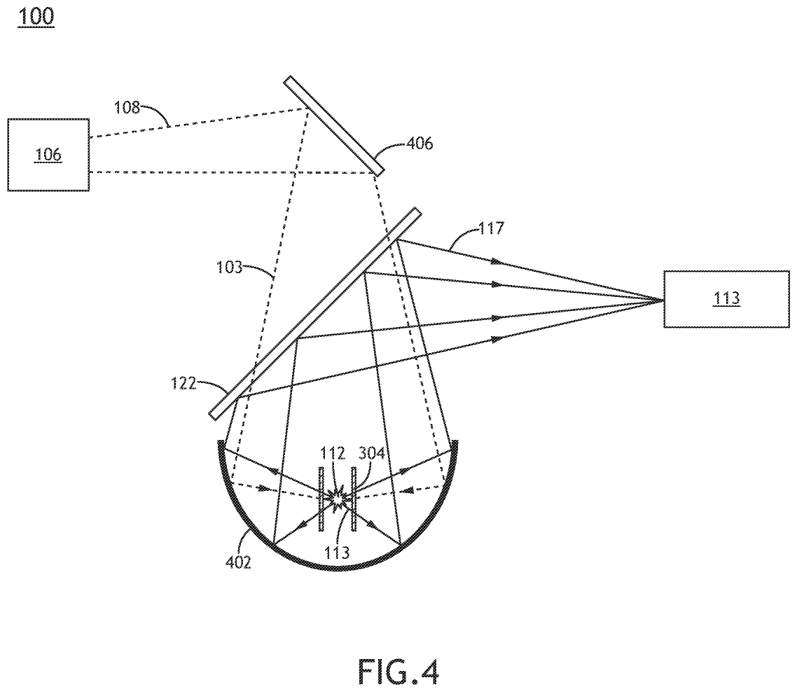

FIG. 4 illustrates a simplified schematic view of the light source 100 with a reflector assembly 400, in accordance with one or more embodiments of the present disclosure. It is noted that the various implementations and components described previously herein with respect to FIGS. 1-3 should be interpreted to extend to FIG. 4 unless otherwise noted. In this embodiment, the collection optical element includes a reflector assembly. For example, the collection optical element may include, but is not limited to, an elliptical reflector assembly 402 and the filter may comprise a filter tube 304 positioned within the reflector assembly 400 with the plasma 112 formed within the volume of the filter tube 304.

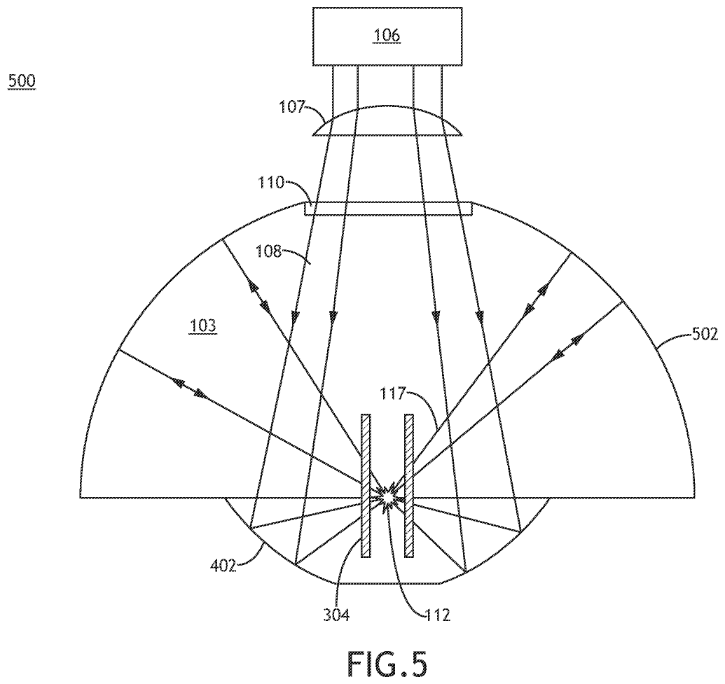

FIG. 5 illustrates a simplified schematic view of the light source 100 with a pressurized reflector assembly 500, in accordance with one or more embodiments of the present disclosure. It is noted that the various implementations and components described previously herein with respect to FIGS. 1-4 should be interpreted to extend to FIG. 5 unless otherwise noted. In this embodiment, the collection optical element includes a composite reflector assembly. For example, the collection optical element may include, but is not limited to, an elliptical reflector and a hemispherical retroreflector coupled to the upper portion of the elliptical reflector to form a pressurized chamber. In this embodiment, the gas mixture (e.g., Kr/Ar) is contained within the pressurized reflector assembly 500, which serves as the gas containment structure and the collection optics. The filter tube 304 may be located within the pressurized chamber 500 with the plasma 112 formed within the volume of the filter tube 304.

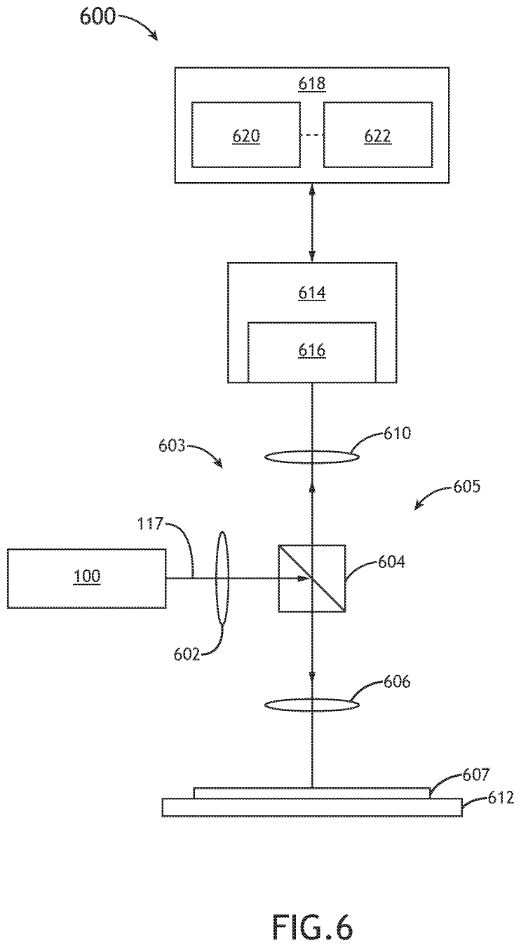

FIG. 6 illustrates a simplified schematic view of an optical characterization system 600 incorporating the compact LSP broadband light source, in accordance with one or more alternative and/or additional embodiments. In embodiments, system 600 includes the LSP light source 100, an illumination arm 603, a collection arm 605, a detector assembly 614, and a controller 618 including one or more processors 620 and memory 622.

It is noted herein that system 600 may comprise any imaging, inspection, metrology, lithography, or other characterization system known in the art. In this regard, system 600 may be configured to perform inspection, optical metrology, lithography, and/or any form of imaging on a sample 607. Sample 607 may include any sample known in the art including, but not limited to, a wafer, a reticle, a photomask, and the like. It is noted that system 600 may incorporate one or more of the various embodiments of the LSP light source 100 described throughout the present disclosure.

In one embodiment, sample 607 is disposed on a stage assembly 612 to facilitate movement of sample 607. Stage assembly 612 may include any stage assembly 612 known in the art including, but not limited to, an X-Y stage, an R-6 stage, and the like. In another embodiment, stage assembly 612 is capable of adjusting the height of sample 607 during inspection or imaging to maintain focus on sample 607.

In one embodiment, the illumination arm 603 is configured to direct broadband light 117 from the Broadband LSP light source 100 to the sample 607. The illumination arm 603 may include any number and type of optical components known in the art. In one embodiment, the illumination arm 603 includes one or more optical elements 602, a beam splitter 604, and an objective lens 606. In this regard, illumination arm 603 may be configured to focus broadband light 117 from the Broadband LSP light source 100 onto the surface of the sample 607. The one or more optical elements 602 may include any optical element or combination of optical elements known in the art including, but not limited to, one or more mirrors, one or more lenses, one or more polarizers, one or more gratings, one or more filters, one or more beam splitters, and the like. It is noted herein that the collection location may include, but is not limited to, one or more of the optical elements 602, a beam splitter 604, or an objective lens 606.

In one embodiment, system 600 includes a collection arm 605 configured to collect light reflected, scattered, diffracted, and/or emitted from sample 607. In another embodiment, collection arm 605 may direct and/or focus the light from the sample 607 to a sensor 616 of a detector assembly 614. It is noted that sensor 616 and detector assembly 614 may include any sensor and detector assembly known in the art. The sensor 616 may include, but is not limited to, a CCD sensor or a CCD-TDI sensor. Further, sensor 616 may include, but is not limited to, a line sensor or an electron-bombardment line sensor.

In one embodiment, detector assembly 614 is communicatively coupled to a controller 618 including one or more processors 620 and memory 622. For example, the one or more processors 620 may be communicatively coupled to memory 622, wherein the one or more processors 620 are configured to execute a set of program instructions stored on memory 622. In one embodiment, the one or more processors 620 are configured to analyze the output of detector assembly 614. In one embodiment, the set of program instructions are configured to cause the one or more processors 620 to analyze one or more characteristics of sample 607. In another embodiment, the set of program instructions are configured to cause the one or more processors 620 to modify one or more characteristics of system 600 in order to maintain focus on the sample 607 and/or the sensor 616. For example, the one or more processors 620 may be configured to adjust the objective lens 606 or one or more optical elements 602 in order to focus broadband light 117 from broadband LSP light source 100 onto the surface of the sample 607. By way of another example, the one or more processors 620 may be configured to adjust the objective lens 606 and/or one or more optical elements 610 in order to collect illumination from the surface of the sample 607 and focus the collected illumination on the sensor 616.

It is noted that the system 600 may be configured in any optical configuration known in the art including, but not limited to, a dark-field configuration, a bright-field orientation, and the like. The system 600 may be configured as any type of metrology tool known in the art such as, but not limited to, a spectroscopic ellipsometer with one or more angles of illumination, a spectroscopic ellipsometer for measuring Mueller matrix elements (e.g., using rotating compensators), a single-wavelength ellipsometer, an angle-resolved ellipsometer (e.g., a beam-profile ellipsometer), a spectroscopic reflectometer, a single-wavelength reflectometer, an angle-resolved reflectometer (e.g., a beam-profile reflectometer), an imaging system, a pupil imaging system, a spectral imaging system, or a scatterometer.

Additional details of various embodiments of optical characterization system 600 are described in U.S. Published U.S. Pat. No. 7,957,066B2, entitled “Split Field Inspection System Using Small Catadioptric Objectives,” issued on Jun. 7, 2011; U.S. Published Patent Application 2007/0002465, entitled “Beam Delivery System for Laser Dark-Field Illumination in a Catadioptric Optical System,” published on Jan. 4, 2007; U.S. Pat. No. 5,999,310, entitled “Ultra-broadband UV Microscope Imaging System with Wide Range Zoom Capability,” issued on Dec. 7, 1999; U.S. Pat. No. 7,525,649 entitled “Surface Inspection System Using Laser Line Illumination with Two Dimensional Imaging,” issued on Apr. 28, 2009; U.S. Published Patent Application 2013/0114085, entitled “Dynamically Adjustable Semiconductor Metrology System,” by Wang et al. and published on May 9, 2013; U.S. Pat. No. 5,608,526, entitled “Focused Beam Spectroscopic Ellipsometry Method and System, by Piwonka-Corle et al., issued on Mar. 4, 1997; and U.S. Pat. No. 6,297,880, entitled “Apparatus for Analyzing Multi-Layer Thin Film Stacks on Semiconductors,” by Rosencwaig et al., issued on Oct. 2, 2001, which are each incorporated herein by reference in their entirety.

The one or more processors 620 of the present disclosure may include any one or more processing elements known in the art. In this sense, the one or more processors 620 may include any microprocessor-type device configured to execute software algorithms and/or instructions. In one embodiment, the one or more processors 620 may consist of a desktop computer, mainframe computer system, workstation, image computer, parallel processor, or other computer system (e.g., networked computer) configured to execute a program configured to operate the system 600 and/or Broadband LSP light source 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non transitory memory medium 622. Moreover, different subsystems of the various systems disclosed may include processor or logic elements suitable for carrying out at least a portion of the steps described throughout the present disclosure. Therefore, the above description should not be interpreted as a limitation on the present disclosure but merely an illustration.

The memory medium 622 may include any storage medium known in the art suitable for storing program instructions executable by the associated one or more processors 620. For example, the memory medium 622 may include a non-transitory memory medium. For instance, the memory medium 622 may include, but is not limited to, a read-only memory, a random access memory, a magnetic or optical memory device (e.g., disk), a magnetic tape, a solid state drive, and the like. In another embodiment, the memory 622 is configured to store one or more results and/or outputs of the various steps described herein. It is further noted that memory 622 may be housed in a common controller housing with the one or more processors 620. In an alternative embodiment, the memory 622 may be located remotely with respect to the physical location of the processors 620. For instance, the one or more processors 620 may access a remote memory (e.g., server), accessible through a network (e.g., internet, intranet, and the like). In another embodiment, memory medium 622 maintains program instructions for causing the one or more processors 620 to carry out the various steps described through the present disclosure.

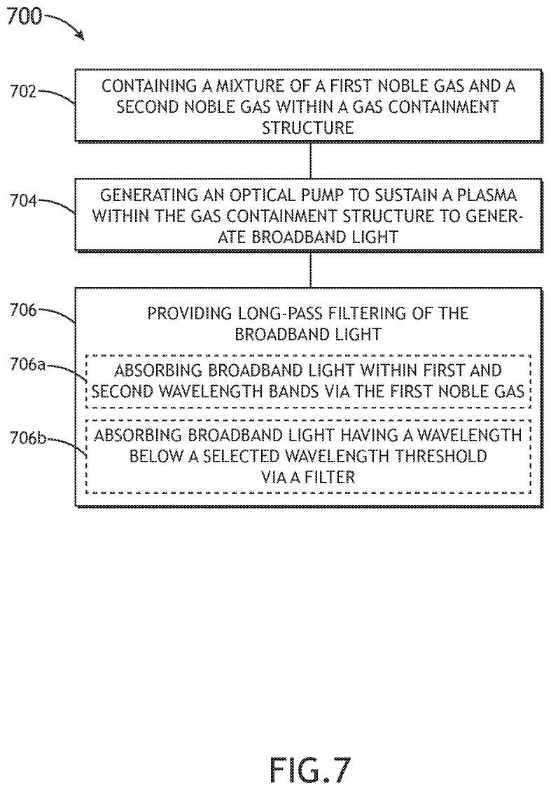

FIG. 7 illustrates a process flow diagram depicting a method 700 generating VUV light with an LSP broadband light source with long-pass filtering, in accordance with one or more alternative and/or additional embodiments. It is noted herein that the steps of method 700 may be implemented all or in part by broadband LSP light source 100. It is further recognized, however, that the method 700 is not limited to the broadband LSP light source 100 in that additional or alternative system-level embodiments may carry out all or part of the steps of method 700.

In step 702, method 700 includes containing a mixture of a first noble gas and a second noble gas within a gas containment structure. In step 704, method 700 includes generating an optical pump and directing the optical pump within the gas containment structure to sustain a plasma within the gas containment structure to generate broadband light. In step 706, method 700 includes long-pass filtering the broadband light via the first noble gas and the filter to provide broadband light having a wavelength below a selected wavelength threshold. The method 700, in additional step 706a, may include absorbing a portion of broadband light within a first wavelength band and a second wavelength band via the first noble gas. The method 700, in additional step 706b include absorbing a portion of the broadband light having a wavelength below a selected wavelength threshold via a filter. In step 708, method 700 includes transmitting filtered broadband light out of the gas containment structure via an output optical window.

One skilled in the art will recognize that the herein described components, operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A laser-sustained broadband light source comprising:
a gas containment structure containing a mixture of a first noble gas and a second noble gas,
a laser pump source configured to generate an optical pump to sustain a plasma within the gas containment structure, wherein the plasma generates broadband light,
wherein the first noble gas absorbs a portion of the broadband light within a first wavelength band and a second wavelength band; and
a filter positioned within the gas containment structure and configured to absorb a portion of the broadband light emitted by the plasma having a wavelength below a selected wavelength threshold, wherein absorption of broadband light by the first noble gas and the filter provide long-pass filtering of broadband light below the selected wavelength threshold to protect one or more downstream optical elements from damage.

2. The broadband light source of claim 1, wherein the absorption of broadband light at the first wavelength by the first noble gas protects the filter from degradation.

3. The broadband light source of claim 1, wherein a transmission edge of the long-pass filtering is tunable via adjustment of a partial pressure of the first noble gas within the gas containment structure.

4. The broadband light source of claim 3, wherein the transmission edge shifts to larger wavelength as the partial pressure of the first noble gas is increased.

5. The broadband light source of claim 1, wherein the first noble gas comprises at least one of krypton or xenon.

6. The broadband light source of claim 1, wherein the second noble gas comprises argon.

7. The broadband light source of claim 1, wherein the filter is formed from at least one of CaF₂ or sapphire.

8. The broadband light source of claim 1, wherein the first noble gas comprises krypton, the second noble gas comprises argon, and the filter is formed from CaF₂.

9. The broadband light source of claim 1, wherein the first noble gas comprises xenon, the second noble gas comprises argon, and the filter is formed from sapphire.

10. The broadband light source of claim 1, wherein filter comprises at least one of a sheet or tube.

11. The broadband light source of claim 1, further comprising:
a collection optical element configured to collect at least a portion of the broadband light emitted from the plasma and direct the portion of the broadband light to the one or more downstream optical elements.

12. The broadband light source of claim 11, wherein the collection optical element comprises at least one of a mirror or lens.

13. The broadband light source of claim 12, wherein the collection optical element comprises a reflector assembly.

14. The broadband light source of claim 13, wherein the collection optical element comprises an elliptical reflector assembly.

15. The broadband light source of claim 13, wherein the collection optical element comprises a composite reflector assembly comprising an elliptical reflector assembly and a hemispherical retroreflector.

16. The broadband light source of claim 1, wherein the one or more downstream optical elements are formed from MgF₂.

17. The broadband light source of claim 1, wherein the one or more downstream optical elements comprise at one of one or more transmissive optical elements or one or more reflective optical elements.

18. The broadband light source of claim 17, wherein the one or more downstream optical elements comprise at least one of a window, a lens, or a mirror.

19. A characterization system comprising:
a broadband light source comprising:
a gas containment structure containing a mixture of a first noble gas and a second noble gas,
a laser pump source configured to generate an optical pump to sustain a plasma within the gas containment structure, wherein the plasma generates broadband light;
wherein the first noble gas absorbs a portion of the broadband light within a first wavelength band and a second wavelength band;
a filter positioned within the gas containment structure and configured to absorb a portion of the broadband light emitted by the plasma having a wavelength below a selected wavelength threshold, wherein absorption of broadband light by the first noble gas and the filter provide long-pass filtering of broadband light below the selected wavelength threshold to protect one or more downstream optical elements from damage; and
a collection optical element configured to collect broadband light emitted from the plasma and direct the broadband light to the one or more downstream optical elements;
a set of illumination optics configured to direct broadband light from the broadband light source to one or more samples;
a set of collection optics configured to collect light emanating from the one or more samples; and
a detector assembly.

20. The characterization system of claim 19, wherein the absorption of broadband light at the first wavelength by the first noble gas protects the filter from degradation.

21. The characterization system of claim 19, wherein a transmission edge of the long-pass filtering is tunable via adjustment of a partial pressure of the first noble gas within the gas containment structure.

22. The characterization system of claim 21, wherein the transmission edge shifts to larger wavelength as the partial pressure of the first noble gas is increased.

23. The characterization system of claim 19, wherein the first noble gas comprises at least one of krypton or xenon.

24. The characterization system of claim 19, wherein the second noble gas comprises argon.

25. The characterization system of claim 19, wherein the filter is formed from at least one of a CaF₂ or sapphire filter.

26. The characterization system of claim 19, wherein the first noble gas comprises krypton, the second noble gas comprises argon, and the filter is formed from CaF₂.

27. The characterization system of claim 19, wherein the first noble gas comprises xenon, the second noble gas comprises argon, and the filter is formed from sapphire.

28. The characterization system of claim 19, wherein filter comprises at least one of a sheet or tube.

29. The characterization system of claim 19, wherein the collection optical element comprises at least one of a mirror or lens.

30. The characterization system of claim 29, wherein the collection optical element comprises a reflector assembly.

31. The characterization system of claim 30, wherein the collection optical element comprises an elliptical reflector assembly.

32. The characterization system of claim 30, wherein the collection optical element comprises a composite reflector assembly comprising an elliptical reflector assembly and a hemispherical retroreflector.

33. The characterization system of claim 19, wherein the one or more downstream optical elements are formed from MgF₂.

34. The characterization system of claim 19, wherein the one or more downstream optical elements comprise at one of one or more transmissive optical elements or one or more reflective optical elements.

35. The characterization system of claim 19, wherein the one or more downstream optical elements comprise at least one of a window, a lens, or a mirror.

36. A method comprising:
containing a mixture of a first noble gas and a second noble gas within a gas containment structure;
generating an optical pump and directing the optical pump within the gas containment structure to sustain a plasma within the gas containment structure to generate broadband light; and
providing long-pass filtering of the broadband light, wherein the providing long-pass filtering of the broadband light comprises:
absorbing a portion of broadband light within a first wavelength band and a second wavelength band via the first noble gas; and
absorbing a portion of the broadband light having a wavelength below a selected wavelength threshold via a filter.
